(19) United States
(12) Patent Application Publication
(10) Pub. No.: US 2015/0340006 A1
(43) Pub. Date: Nov. 26, 2015

(54) Upgrading Device and Upgrading Method of Signal Motherboard for Display Device

(71) Applicant: BOE TECHNOLOGY GROUP CO., LTD., Beijing (CN)

(72) Inventors: Lijun SU, Beijing (CN); Yongjie LU, Beijing (CN); Jianjian WANG, Beijing (CN)

(21) Appl. No.: 14/525,573

(22) Filed: Oct. 28, 2014

(30) Foreign Application Priority Data
May 20, 2014 (CN) 201410213433.5

(51) Int. Cl. G09G 5/00

(52) U.S. Cl. CPC G09G 5/006

(57) ABSTRACT

The invention provides an upgrading device and method of a signal motherboard for a display device. The upgrading device of a signal motherboard for a display device comprises a switch unit, configured to be connected with a switch interface of the signal motherboard and control an operating state of the signal motherboard; and a storage unit storing content for upgrading the signal motherboard, configured to be connected with an information interface of the signal motherboard. The upgrading method includes steps of: connecting the switch unit to the switch interface of the signal motherboard, and connecting the storage unit to the information interface of the signal motherboard; setting the signal motherboard to be in a pause state by the switch unit; and writing the content for upgrading the signal motherboard stored in the storage unit into the signal motherboard to upgrade the signal motherboard.

### FIELD OF THE INVENTION

The present invention relates to the field of display technology, and particularly relates to an upgrading device and an upgrading method of a signal motherboard for a display device.

### BACKGROUND OF THE INVENTION

A display device, such as a television and the like, is provided with a signal motherboard for converting a video signal to a format identifiable by a display panel (e.g. liquid crystal display panel), to drive and control the display process of the display panel. With the development of the technology, driver software of the signal motherboard needs to be upgraded frequently to obtain better performance without replacing hardware.

According to existing methods, the upgrading process of a signal motherboard is relatively complicated. Taking upgrading of an Mstar V39 signal motherboard (a signal motherboard for driving a liquid crystal display panel) as an example, a computer installed with a specific upgrade program needs to be used, a USB interface (universal serial bus interface) of the computer is then connected to a USB to TTL (transistor-transistor logic) board, whose TTL interface is connected to a TTL interface of the signal motherboard, and finally predetermined upgrade content is written into the signal motherboard by the computer; the above upgrading process needs about 5 minutes, which is time consuming, and the computer and the interface converting board are required, so complicated equipment is required and cost is high.

### SUMMARY OF THE INVENTION

Technical problems to be solved by the present invention include providing an upgrading device and upgrading method of a signal motherboard for a display device with the advantages of short time consumption and simple structure, in view of the problem that an existing way of upgrading a signal motherboard is time consuming and requires complicated equipment.

A technical solution used to solve the technical problems of the present invention is an upgrading device of a signal motherboard for a display device, comprising:

a switch unit, which is configured to be connected with a switch interface of the signal motherboard and control an operating state of the signal motherboard; and

a storage unit, which stores content for upgrading the signal motherboard, and is configured to be connected with an information interface of the signal motherboard.

Preferably, the switch unit includes a key switch.

Preferably, the storage unit includes a universal serial bus flash disk.

Preferably, the upgrading device of a signal motherboard for a display device further comprises an indication unit, which is configured to be connected with an indication interface of the signal motherboard and indicate an upgrade state of the signal motherboard.

Further preferably, the indication unit includes a light emitting diode.

Preferably, the upgrading device of a signal motherboard for a display device further comprises a power supply, which is configured to be connected with a power interface of the signal motherboard and supply power to the signal motherboard.

A technical solution used to solve the technical problems of the present invention is an upgrading method of a signal motherboard for a display device by using the above upgrading device of a signal motherboard for a display device, and the upgrading method includes steps of:

S1. connecting the switch unit to the switch interface of the signal motherboard, and connecting the storage unit to the information interface of the signal motherboard;

S2. setting the signal motherboard to be in a pause state by the switch unit; and

S3. writing the content for upgrading the signal motherboard stored in the storage unit into the signal motherboard, to upgrade the signal motherboard.

Preferably, the upgrading device of a signal motherboard for a display device further comprises an indication unit, which is configured to be connected with an indication interface of the signal motherboard and indicate an upgrade state of the signal motherboard; and in this case, the upgrading method further includes, before step S3, a step of: connecting the indication unit to the indication interface of the signal motherboard, to indicate the upgrade state of the signal motherboard in step S3.

Preferably, the upgrading device of a signal motherboard for a display device further comprises a power supply, which is configured to be connected with a power interface of the signal motherboard and supply power to the signal motherboard; and in this case, the upgrading method further includes, before step S3, a step of: connecting the power supply to the power interface of the signal motherboard, to supply power to the signal motherboard.

According to the operating principle of a signal motherboard for a display device, when the signal motherboard is in the pause state, data can be written therein directly via the information interface; in the upgrading device of a signal motherboard for a display device of the embodiment, since it comprises the switch unit, the signal motherboard can be directly set to be in the pause state, so that the content for upgrading the signal motherboard stored in the storage unit can be directly written into the signal motherboard for upgrading, the upgrading process of the signal motherboard only needs a short time of 50-60 seconds without using a computer, an interface converting board or the like, and the upgrading device is simple in structure and low in cost.

The upgrading device and the upgrading method of a signal motherboard for a display device of the present invention are used for upgrading a signal motherboard for a display device, and may be used for upgrading, for example, an Mstar V39 signal motherboard.

### BRIEF DESCRIPTION OF THE DRAWINGS

FIG. 1 is a schematic block diagram of an upgrading device of a signal motherboard for a display device of Embodiment 1 of the present invention; and

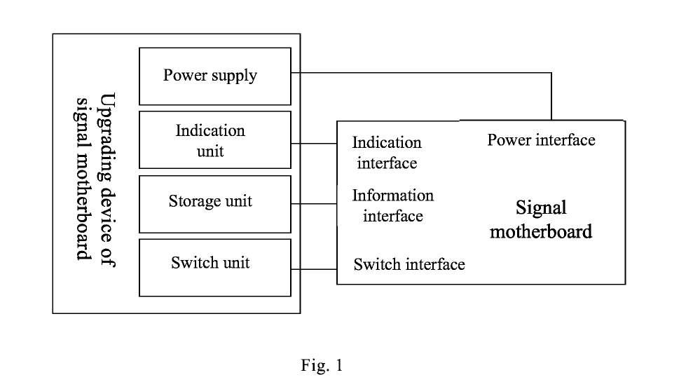

FIG. 2 is a schematic flowchart of an upgrading method of a signal motherboard for a display device by using the upgrading device of a signal motherboard for a display device of Embodiment 1 of the present invention.

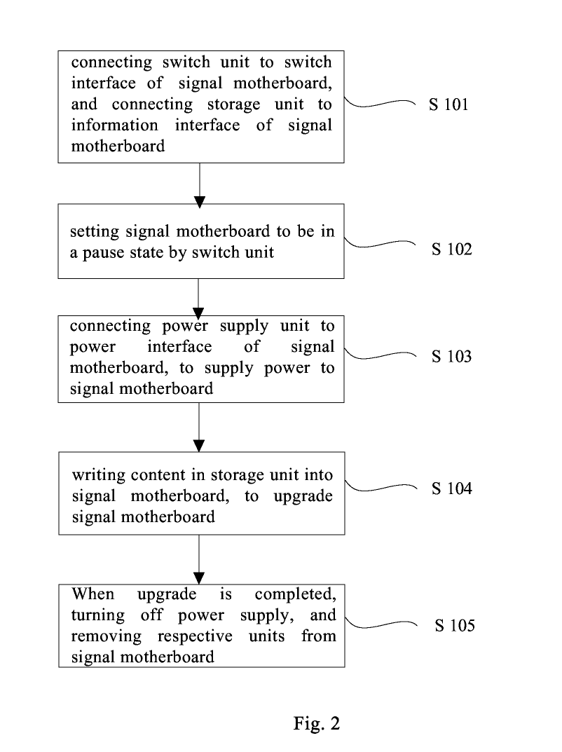

### DETAILED DESCRIPTION OF THE EMBODIMENTS

To make a person skilled in the art better understand the technical solution of the present invention, the present invention is further described below in details in conjunction with the accompanying drawings and the specific implementations.

Embodiment 1:

The embodiment provides an upgrading device and upgrading method of a signal motherboard for a display device.

Here, the upgrading device of a signal motherboard for a display device is used for upgrading a signal motherboard for a display device; in the display device, the signal motherboard is mainly used for driving and controlling the display process of a display panel.

Preferably, the upgrading device of a signal motherboard for a display device is an upgrading device of an Mstar V39 signal motherboard or an upgrading device of a signal motherboard of other type. Here, the Mstar V39 signal motherboard is a signal motherboard for a liquid crystal display panel.

That is to say, the embodiment is described by taking an upgrading device for upgrading an Mstar V39 signal motherboard as an example. Of course, it should be understood that the upgrading device of a signal motherboard for a display device of the embodiment is not limited thereto, and may also be used for upgrading other type of signal motherboard for a display device.

Specifically, the upgrading device of a signal motherboard for a display device of the embodiment at least comprises a switch unit and a storage unit.

The switch unit is configured to be connected with a switch interface of the signal motherboard and control an operating state of the signal motherboard; and the storage unit stores content for upgrading the signal motherboard, and is configured to be connected with an information interface of the signal motherboard.

Here, the “operating states” of the signal motherboard may include two states, one is a driving state in which a driving signal is sent to the display panel to enable the display panel to display; and the other is a state of the signal motherboard when the display panel is turned off, i.e. a “pause state”; it should be understood that the “pause state” only indicates that at present the signal motherboard does not drive the display panel to display, but the signal motherboard is still on (i.e. still in an operating state), and is not turned off completely. The signal motherboard may be switched between the two operating states according to a signal from the switch interface thereof. Of course, the signal motherboard may also have other operating state, which is not limited herein.

According to the operating principle of the signal motherboard, when the signal motherboard is in the pause state, data can be written therein directly via the information interface, so the signal motherboard needs to be set to be in the pause state before the upgrade starts. In a conventional display device (e.g. television), a switch interface of a signal motherboard is connected to a switch key (POWER key) on the display device, and a user can press the switch key to turn on or turn off a display panel, i.e. setting the signal motherboard to be in a driving state or a pause state; during the upgrading of the signal motherboard, the signal motherboard is not connected to the switch key of the display device, so a switch unit needs to be provided to be connected with the switch interface of the signal motherboard, to conveniently and directly set the signal motherboard to be in the pause state, so that the content for upgrading the signal motherboard stored in the storage unit can be directly written into the signal motherboard for upgrading. The above upgrading process only needs a short time of 50-60 seconds without using a computer, an interface converting board or the like, and the upgrading device is simple in structure and low in cost.

Preferably, the switch unit includes a key switch, which is configured to be connected with the switch interface on the signal motherboard.

That is to say, a key switch with two states “on and off” may be used as the switch unit, and the key switch is connected with the switch interface on the signal motherboard, and in this way, the signal motherboard can be switched between different operating states by simply toggling the key switch, thus the operation is convenient.

Preferably, the storage unit is a universal serial bus flash disk (i.e. U disk), and the corresponding information interface of the signal motherboard for a display device may be a universal serial bus interface (i.e. USB interface).

That is to say, the storage unit is preferably a U disk, which is a common storage device with simple structure and low cost; and the Mstar V39 signal motherboard is also provided with a USB interface, so a U disk serving as the storage unit can be directly connected with the USB interface on the signal motherboard, thus the operation is convenient.

Preferably, the upgrading device of a signal motherboard for a display device of the embodiment further comprises an indication unit, which is configured to be connected with an indication interface of the signal motherboard to indicate an upgrade state of the signal motherboard. More preferably, the indication unit includes a light emitting diode (LED), which is configured to be connected with the indication interface of the signal motherboard.

The upgrading device of a signal motherboard for a display device of the embodiment does not comprise a device with a display function, such as a computer or the like, and therefore, it is impossible for the user to know whether the upgrading process is completed. Thus, a light emitting diode may be additionally provided and connected to the indication interface on the Mstar V39 signal motherboard, and in this way, the light emitting diode can automatically emit red light during the upgrading process and emit green light after the upgrading process is completed, so that the user can determine whether upgrade is completed according to the color of the light emitting diode.

Of course, the above example of the indication unit is not limited to the light emitting diode, and may also be any other device capable of indicating whether upgrade is completed, such as a speaker capable of making a specific sound after upgrade is completed.

Preferably, the upgrading device of a signal motherboard of the embodiment further comprises a power supply, which is configured to be connected with a power interface of the signal motherboard and supply power to the signal motherboard.

Obviously, to perform upgrade, the signal motherboard must be powered on, and to this end, a power supply may be additionally provided in the upgrading device of a signal motherboard, to supply power to the signal motherboard.

Of course, if no power supply is provided in the upgrading device of a signal motherboard, it is also feasible to use other external power supply (e.g. power supply of the display device) to supply power to the signal motherboard during upgrade.

The embodiment also provides an upgrading method of a signal motherboard by using the upgrading device of a signal motherboard for a display device, and the upgrading method includes steps S101 to S105.

S101. the switch unit is connected to the switch interface of the signal motherboard, and the storage unit is connected to the information interface of the signal motherboard. Preferably, if an indication unit is provided, this step further includes a step of connecting the indication unit to an indication interface of the signal motherboard.

That is to say, the above-described switch key, the U disk and the light emitting diode are connected to the USB interface, the switch interface and the indication interface of the signal motherboard, respectively.

S102. the signal motherboard is set to be in a pause state by the switch unit.

That is to say, the switch key is toggled, to set the signal motherboard to be in the pause state.

S103. the power supply is connected to the power interface of the signal motherboard, to supply power to the signal motherboard.

That is to say, the power supply is connected to the power interface of the signal motherboard, and the power supply is turned on, so that the signal motherboard is powered on.

S104. the content for upgrading the signal motherboard stored in the storage unit is written into the signal motherboard, to upgrade the signal motherboard.

When the signal motherboard is in the above state, the content for upgrading the signal motherboard stored in a specific directory of the U disk can be automatically written into the signal motherboard, so that the upgrading process is completed. The light emitting diode emits red light during the upgrading process.

S105. when upgrade is completed, the power supply is turned off, and the respective units are removed from the signal motherboard.

That is to say, it indicates completion of upgrade when the light emitting diode starts to emit green light; at that time, the power supply can be turned off, so that the signal motherboard is powered off, and then the above switch key, U disk, light emitting diode, power supply, etc. are removed for upgrading the next signal motherboard.

It can be understood that the above implementations are only exemplary implementations for illustrating the principle of the present invention, but the present invention is not limited thereto. Various variations and improvements may be made by the person of ordinary skill in the art without departing from the spirit and essence of the present invention, and these variations and improvements should also be considered to be within the protection scope of the present invention.

1. An upgrading device of a signal motherboard for a display device, comprising:
a switch unit, which is configured to be connected with a switch interface of the signal motherboard and control an operating state of the signal motherboard; and
a storage unit, which is configured to store content for upgrading the motherboard, and be connected with an information interface of the signal motherboard.

2. The upgrading device of a signal motherboard for a display device according to claim 1, wherein the switch unit includes a key switch.

3. The upgrading device of a signal motherboard for a display device according to claim 1, wherein the storage unit includes a universal serial bus flash disk.

4. The upgrading device of a signal motherboard for a display device according to claim 1, further comprising an indication unit, which is configured to be connected with an indication interface of the signal motherboard and indicate an upgrade state of the signal motherboard.

5. The upgrading device of a signal motherboard for a display device according to claim 4, wherein the indication unit includes a light emitting diode.

6. The upgrading device of a signal motherboard for a display device according to claim 1, further comprising a power supply, which is configured to be connected with a power interface of the signal motherboard and supply power to the signal motherboard.

7. An upgrading method of a signal motherboard for a display device by using the upgrading device of a signal motherboard for a display device of claim 1, including steps of:
S1. connecting the switch unit to the switch interface of the signal motherboard, and connecting the storage unit to the information interface of the signal motherboard;
S2. setting the signal motherboard to be in a pause state by the switch unit; and
S3. writing the content for upgrading the signal motherboard stored in the storage unit into the signal motherboard, to upgrade the signal motherboard.

8. The upgrading method according to claim 7, wherein the upgrading device of a signal motherboard for a display device further comprises an indication unit, which is configured to be connected with an indication interface of the signal motherboard and indicate an upgrade state of the signal motherboard; and wherein the upgrading method further includes, before step S3, a step of: connecting the indication unit to the indication interface of the signal motherboard, to indicate the upgrade state of the signal motherboard in step S3.

9. The upgrading method according to claim 7, wherein the upgrading device of a signal motherboard for a display device further comprises a power supply, which is configured to be connected with a power interface of the signal motherboard and supply power to the signal motherboard; and wherein the upgrading method further includes, before step S3, a step of: connecting the power supply to the power interface of the signal motherboard, to supply power to the signal motherboard.
